(19) United States
(12) Patent Application Publication
(10) Pub. No.: US 2013/0260046 A1
(43) Pub. Date: Oct. 3, 2013

(54) DIE COATER AND METHOD FOR PRODUCING COATING FILM

(71) Applicant: NITTO DENKO CORPORATION, Osaka (JP)

(72) Inventors: Makoto Komatsubara, Ibaraki-shi (JP); Yoshifumi Morita, Ibaraki-shi (JP); Osamu Suzuki, Ibaraki-shi (JP)

(73) Assignee: NITTO DENKO CORPORATION, Osaka (JP)

(21) Appl. No.: 13/799,236

(22) Filed: Mar. 13, 2013

(30) Foreign Application Priority Data
Mar. 29, 2012 (JP) 2012-076300

(51) Int. Cl. B05C 3/18

(52) U.S. Cl. CPC B05C 3/18
USPC 427/430.1; 118/712

(57) ABSTRACT

A die coater includes: a detecting section which detects a thickness of a coating film formed on a substrate; and a controlling section which can control the quantity of a supply flow of a coating liquid to be supplied to a cavity by a supplying section and the quantity of an ejection flow of the coating liquid to be ejected from the cavity by an ejecting section, on the basis of a detection result of the detecting section, when a coating width in a longitudinal direction of a slot has been changed.

### CROSS REFERENCE TO RELATED APPLICATION

The present application claims priority of Japanese Patent Application No. 2012-076300, which are incorporated in the specification of the present application by reference.

### BACKGROUND OF THE INVENTION

1. Field of the Invention

The present invention relates to a die coater and a method for producing a coating film.

2. Description of the Related Art

Conventionally, a the coater is known as one of coating applicators, which has a slot that discharges a coating liquid and a cavity that supplies the coating liquid to the slot provided in a die. The die coater supplies the coating liquid to the cavity, extrudes the coating liquid to the slot from the cavity, and simultaneously applies the coating liquid onto a substrate such as a film, which is brought close to the slot and is moved relatively with respect to the slot.

There is such a case in this type of the die coater that the dispersion in the thickness (film thickness) of the coating film occurs along a longitudinal direction of the slot and the coating film with a uniform thickness is not obtained.

Then, a technology is proposed which uses a coating applicator that has a cavity for supplying a coating liquid to a slot which has a constant coating width in a longitudinal direction, a supplying section which supplies the coating liquid to the cavity, and an ejecting section which ejects the coating liquid from the cavity, adjusts the quantity of an ejection flow of the coating liquid to be ejected from the cavity, thereby uniformizes a discharge quantity of the coating liquid to be discharged from the slot throughout the above described longitudinal direction, and uniformizes the thickness of the coating film throughout the above described longitudinal direction (Patent Document 1).

### PRIOR ART DOCUMENTS

### Patent Documents

Patent Document 1: Japanese Patent Application Laid-Open No. 2009-28685

### SUMMARY OF THE INVENTION

Incidentally, there is the case in which a die coater including the die coater as in Patent Document 1 generally coats a substrate so as to form variously different coating widths according to the application and the like. For instance, when a substrate with a comparatively wide width and a substrate with a comparatively narrow width are coated so as to have the same coating width, the substrate with the comparatively wide width produces heavy losses of the material (substrate) which has not been coated. Accordingly, in order to avoid such a loss, the coating width is occasionally changed so as to match the substrate to be coated.

However, in such a case, when one die coater is used while changing the coating width, an unpredictable dispersion in the film thickness occurs. For this reason, conventionally, it has been necessary to use a plurality of die coaters with different coating widths.

In addition, also when the coating has been changed in the above described die coater as in Patent Document 1, the dispersion in a pressure in the coating liquid in the cavity largely changes immediately after the coating width has been changed, and a large dispersion in the film thickness occurs. For this reason, it has not been possible at all for such a die coater to adopt a structure of changing the coating width.

With respect to the above described problems, an object of the present invention is to provide a die coater which can achieve a coating film with a comparatively small dispersion in the film thickness throughout a longitudinal direction of a slot while appropriately changing the coating width in the longitudinal direction, and a method for producing the coating film.

As a result of having made an extensive investigation on the above described problems, the present inventors have found the following facts.

Specifically, when a coating width in a longitudinal direction of a slot is changed, the quantity of the passing flow per unit coating width of a coating liquid passing through the slot changes, and the whole film thickness of the coating film formed on the substrate (average value of film thickness) in the above described longitudinal direction (width direction of coating film) results in being changed.

More specifically, when the quantity of the supply flow of the coating liquid to be supplied to a cavity and the quantity of the ejection flow of the coating liquid to be ejected from the cavity are set for a predetermined coating width, and then the coating width is decreased, the above described quantity of the passing flow increases, and the whole film thickness in the above described longitudinal direction increases as compared to that before the coating width is changed. On the other hand, when the coating width is increased, the above described quantity of the passing flow decreases, and the whole film thickness in the above described longitudinal direction decreases as compared to that before the coating width is changed.

Because of this, in order that the film thickness of the coating film is set so as to be constant before and after the coating width is changed, the coating liquid needs to be applied with a smaller quantity of the supply flow than that before the coating width is changed so that the above described quantity of the passing flow becomes constant before and after the coating width is changed, when the coating width has been decreased; and on the other hand, the coating liquid needs to be applied in a larger quantity of the supply flow than that before the coating width is changed so that the above described quantity of the passing flow becomes constant before and after the coating width is changed, when the coating width has been increased.

However, in a case where the quantity of the flow has been set in this way, when the coating width has been decreased, a pressure loss in a downstream side with respect to an upstream side in a flow direction of the coating liquid passing through the cavity increases as compared to that before the coating width is decreased. Thereby, the coating film of a portion in which the coating film has been formed by discharge in the above described downstream side becomes thinner than that in other portions. On the other hand, when the coating width has been increased, the above described pressure loss decreases as compared to that before the coating width is increased, and the coating film of a portion in which the coating film has been formed by the discharge in the above described downstream side becomes thicker than that in other portions.

Thus, it has been found that when the coating width has been changed, dispersion is caused in the quantity of the passing flow of the coating liquid passing through the slot in the above described longitudinal direction, and the dispersion is caused in the film thickness of the coating film in the above described longitudinal direction.

As a result of having made a further extensive investigation on the basis of such a knowledge, the present inventors have found out that when the coating width has been decreased, the change of the above described pressure loss before and after the coating width is changed can be suppressed by setting the above described quantity of the passing flow so as to be constant before and after the coating width is changed, and controlling the above described quantity of the supply flow and quantity of the ejection flow so as to decrease as compared to those before the coating width is changed. In addition, the present inventors have found out that when the coating width has been increased, the change of the above described pressure loss before and after the coating width is changed can be suppressed by setting the above described quantity of the passing flow so as to be constant before and after the coating width is changed, and controlling the above described quantity of the supply flow and quantity of the ejection flow so as to increase as compared to those before the coating width is changed.

Specifically, the change of the above described pressure loss before and after the coating width is changed can be suppressed even though the coating width has been appropriately changed, by setting the above described quantity of the passing flow before and after the coating width is changed so as to be constant, and changing the above described quantity of the supply flow and quantity of the ejection flow from those before the coating width is changed. Thereby, the present inventors have found out that the dispersion in the quantity of the passing flow of the coating liquid in the above described longitudinal direction can be comparatively decreased.

In addition, the change of the quantity of the passing flow per unit coating width when the coating width has been changed and the dispersion in the quantity of the passing flow in the above described longitudinal direction appear as the change of the whole film thickness of the coating film in the above described longitudinal direction and as the dispersion in the thickness of the coating film in the above described longitudinal direction. Thus, the present inventors have found out that when the coating width has been changed as described above, the dispersion in the quantity of the passing flow of the above described coating liquid in the above described longitudinal direction, which varies before and after the coating width is changed, can be comparatively decreased by detecting the thickness of the coating film, and controlling the above described quantity of the supply flow and the above described quantity of the ejection flow, on the basis of the obtained detection result; and have accomplished the present invention.

Specifically, a die coater according to the present invention, which has a slot that discharges a coating liquid and a cavity that is arranged along a longitudinal direction of the slot and supplies the coating liquid to the slot, and discharges the coating liquid onto a substrate from the slot to form a coating film on the substrate, wherein

the die coater is structured so as to be capable of changing a coating width in the longitudinal direction of the slot, and includes:

a supplying section which supplies the coating liquid to a first side in the longitudinal direction of the cavity, and an ejecting section which ejects the coating liquid from a second side in the longitudinal direction, wherein the sections are structured so that a part of the coating liquid supplied to the cavity by the supplying section passes through the slot, and simultaneously the remaining part of the coating liquid is ejected by the ejecting section;

a detecting section which can detect a thickness of the coating film formed on the substrate; and

a controlling section which can control the quantity of a supply flow of the coating liquid to be supplied by the supplying section and the quantity of an ejection flow of the coating liquid to be ejected by the ejecting section, on the basis of a detection result of the detecting section, when the coating width has been changed.

The die coater with such a structure can control the quantity of the passing flow of the coating liquid per unit width so as to become constant before and after the coating width is changed, and can control the above described quantity of the supply flow and quantity of the ejection flow so as to decrease as compared to those before the coating width is changed, on the basis of the detection result of the thickness of the coating film, when the coating width has been decreased. Thereby, the die coater can suppress the phenomenon that a pressure loss in a second side (downstream side) with respect to that in a first side (upstream side) changes in the coating liquid which moves through the cavity, before and after the coating width is changed. In addition, when the coating width has been increased, the die coater can control the above described quantity of the passing flow so as to become constant before and after the coating width is changed, and can control the above described quantity of the supply flow and the above described quantity of the ejection flow so as to increase as compared to those before the coating width is changed, on the basis of the detection result of the thickness of the coating film. Thereby, the die coater can suppress the phenomenon that the above described pressure loss changes before and after the coating width is changed.

Thus, because of being provided with the above described detecting section and controlling section, the coater can suppress the phenomenon that the above described pressure loss changes before and after the coating width is changed even though the coating width has been appropriately changed, and can comparatively decrease the dispersion in the quantity of the passing flow (quantity of discharge flow) of the coating liquid passing through the slot, in a longitudinal direction (width direction of coating film) of the slot.

Accordingly, the die coater can appropriately change the coating width in the longitudinal direction of the slot and simultaneously achieve a coating film having a comparatively small dispersion in the film thickness throughout the longitudinal direction.

In addition, in the die coater, it is preferable that the controlling section is structured so that when the thickness of the coating film is larger than that before the coating width is changed, the controlling section controls the quantity of a passing flow of the coating liquid passing through the slot per unit coating width so as to become constant before and after the coating width is changed, and controls the quantity of the supply flow and the quantity of the ejection flow so as to decrease as compared to those before the coating width is changed, and so that when the thickness of the coating film is smaller than that before the coating width is changed, the controlling section controls the quantity of the passing flow so as to become constant before and after the coating width is changed, and controls the quantity of the supply flow and the quantity of the ejection flow so as to increase as compared to those before the coating width is changed, on the basis of the detection result of the detecting section.

This structure can more surely suppress the dispersion in the discharge quantity of the coating liquid to be discharged from the slot, in the above described longitudinal direction.

In addition, in the die coater, it is preferable that the coating liquid has such viscosity that when the viscosity is measured in a range of a shear rate of 20 to 2,000 (1/s), n is outside a range of 0.99 to 1.01 in the equation of μ=μ₀·γ^{n·1} obtained for the viscosity μ [Pa·s], a zero shear viscosity μ₀ [Pa·s] and a shear rate γ [1/s].

Here, in the coating liquid in which the above described n is outside the range of 0.99 to 1.01, as the shear rate increases, the viscosity increases or decreases largely, and the discharge quantity of the coating liquid discharged from the slot tends to easily disperse in the longitudinal direction, as compared to the coating liquid in which the above described n is within the range of 0.99 to 1.01. However, the above described die coater can suppress the dispersion in the discharge quantity of the coating liquid even when the coating liquid of which the discharge quantity tends to easily disperse is used in this way, which is accordingly useful.

In addition, in the die coater, it is preferable that the coating liquid is one or more solutions selected from the group consisting of a rubber-based solution, an acrylic solution, a silicone-based solution, a urethane-based solution, a vinyl alkyl ether-based solution, a polyvinyl alcohol-based solution, a polyvinylpyrrolidone-based solution, a polyacrylamide-based solution and a cellulose-based solution.

According to another aspect of the present invention, there is provided a method for producing a coating film, which produces the coating film on a substrate, and includes a coating step of using a die coater provided with a slot which discharges a coating liquid and a cavity which supplies the coating liquid to the slot, supplying the coating liquid to a first side in a longitudinal direction of the cavity, passing a part of the supplied coating liquid through the slot, simultaneously ejecting the remaining part of the coating liquid from a second side in the longitudinal direction of the cavity, and thereby discharging the part of the coating liquid onto the substrate from the slot, wherein

in the coating step, the coating film is produced on the substrate from the part of the coating liquid which has been discharged from the slot, wherein

when the coating width has been changed so as to become small, the quantity of a passing flow of the coating liquid passing through the slot per unit coating width is controlled so as to be constant before and after the coating width is changed, and the quantity of a supply flow of the coating liquid to be supplied to the first side and the quantity of an ejection flow of the coating liquid to be ejected from the second side are controlled so as to decrease as compared to those before the coating width is changed; and

when the coating width has been changed so as to become large, the quantity of the passing flow is controlled so as to be constant before and after the coating width is changed, and the quantity of the supply flow and the quantity of the ejection flow are controlled so as to increase as compared to those before the coating width is changed.

As described above, the present invention can achieve a coating film with a comparatively small dispersion in film thickness throughout a longitudinal direction of a slot, while the coating width in the longitudinal direction is appropriately changed.

### BRIEF DESCRIPTION OF THE DRAWINGS

FIG. 1 is a schematic block diagram illustrating a die coater according to one embodiment of the present invention;

FIG. 2 is a schematic perspective view of a die head;

FIG. 3A is a schematic side view of the die in FIG. 2;

FIG. 3B is a schematic top plan view of the die in FIG. 2;

FIG. 4A is a schematic exploded side view of the in FIG. 3;

FIG. 4B is a schematic top plan view of a first die block in FIG. 4A;

FIG. 4C is a schematic top plan view of a shim in FIG. 4A;

FIG. 4D is a schematic top plan view of a second the block in FIG. 4A;

FIG. 5A is a schematic top plan view illustrating one embodiment of a cavity, a slot and a shim;

FIG. 5B is a schematic top plan view illustrating one embodiment of the cavity, the slot and the shim;

FIG. 6 is a schematic partial side view illustrating a state in which a die coater of the present embodiment conducts application;

FIG. 7 is a schematic plan view schematically illustrating the periphery of the cavity when a coating width is comparatively large; and

FIG. 8 is a schematic plan view schematically illustrating the periphery of the cavity when a coating width is comparatively small.

### DETAILED DESCRIPTION OF THE PREFERRED EMBODIMENTS

An embodiment of a die coater and a method for producing a coating film according to the present invention will be described below with reference to the drawings.

Firstly, an embodiment of the die coater according to the present invention will be described below.

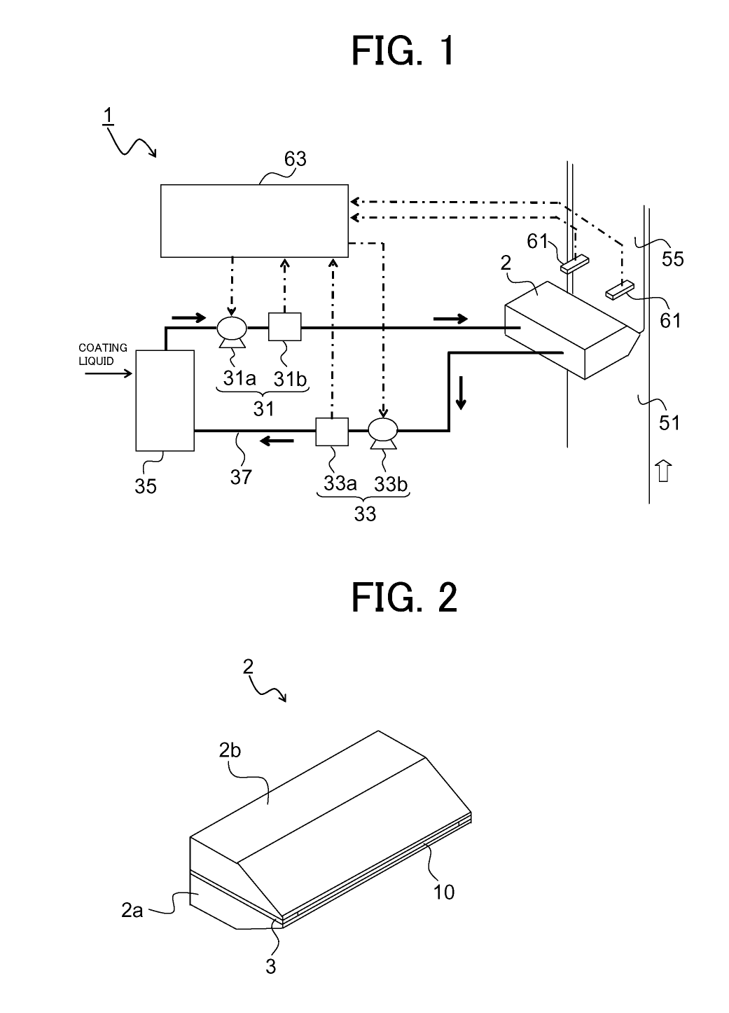

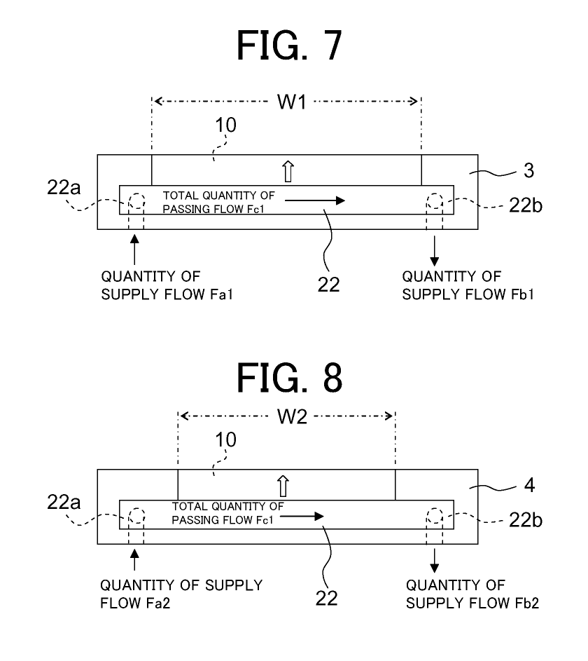

As is illustrated in FIG. 1, the die coater 1 of the present embodiment includes: a die 2 which discharges a supplied coating liquid 5 therefrom (see FIG. 6) onto a substrate 51; a plurality of shims (for instance, shim 3, shim 4, see FIG. 7 and FIG. 8) which are detachably mounted on the die 2 and have different coating widths from each other; a supplying section 31 which supplies the coating liquid 5 to the die 2; an ejecting section 33 which ejects the coating liquid 5 from the die 2; a storing section 35 for storing the coating liquid 5 therein; a conduit 37 for connecting these components to each other; a detecting section 61 for detecting the thickness of the coating film 55 formed on the substrate 51; and a controlling section 63 for controlling the quantity of the supply flow of the coating liquid 5 by the supplying section 31 and the quantity of the ejection flow of the coating liquid 5 by the ejecting section 33, on the basis of the detection result in the detecting section 61. Incidentally, in FIG. 1, an arrow of a solid line shows a flow of the coating liquid 5.

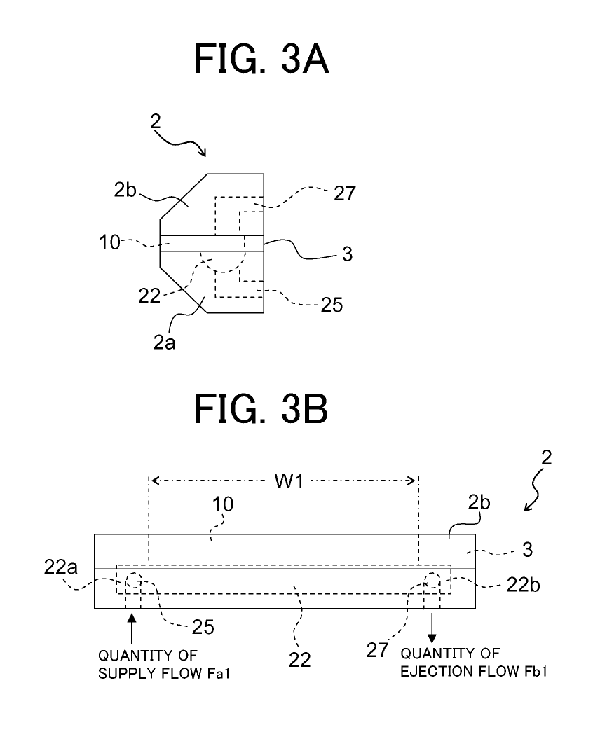

In addition, as is illustrated in FIG. 1 to FIG. 3, the die 2 is provided with a slot 10 which discharges the coating liquid 5 (see FIG. 6), and a cavity 22 which is arranged along a longitudinal direction (horizontal direction of FIG. 3B, hereinafter occasionally referred to simply as longitudinal direction) of the slot 10 and supplies the coating liquid 5 to the slot 10.

More specifically, as is illustrated in FIG. 2 to FIG. 4, the die 2 includes a first die block 2a and a second die block 2b which are arranged so as to face each other so that the slot 10 is formed at the distal end portion. The first die block 2a has a recessed portion formed therein along the above described longitudinal direction, and the recessed portion is structured so as to form the cavity 22 by being covered with the second the block 2b. The cavity 22 and the slot 10 communicate with each other, and the cavity 22 is structured so as to supply the coating liquid 5 to the slot 10 therefrom. In addition, as are illustrated in FIG. 3A and FIG. 3B, the length in the transverse direction of the cavity 22 is formed so as to be constant throughout the longitudinal direction, and the height of the cavity 22 is also formed so as to be constant throughout the longitudinal direction.

The recessed portion for forming the cavity 22 may also be formed in the second the block 2b. In addition, the recessed portions may be formed on the first die block 2a and the second the block 2b, respectively, and the cavity 22 in which these recessed portions butt against each other may be formed by the first die block 2a and the second die block 2b which have been arranged so as to face each other.

As is illustrated in FIG. 3A and FIG. 3B, the length in the transverse direction of the slot 10 is formed so as to be constant along the longitudinal direction, and the height of the opening is also formed so as to be constant throughout the longitudinal direction.

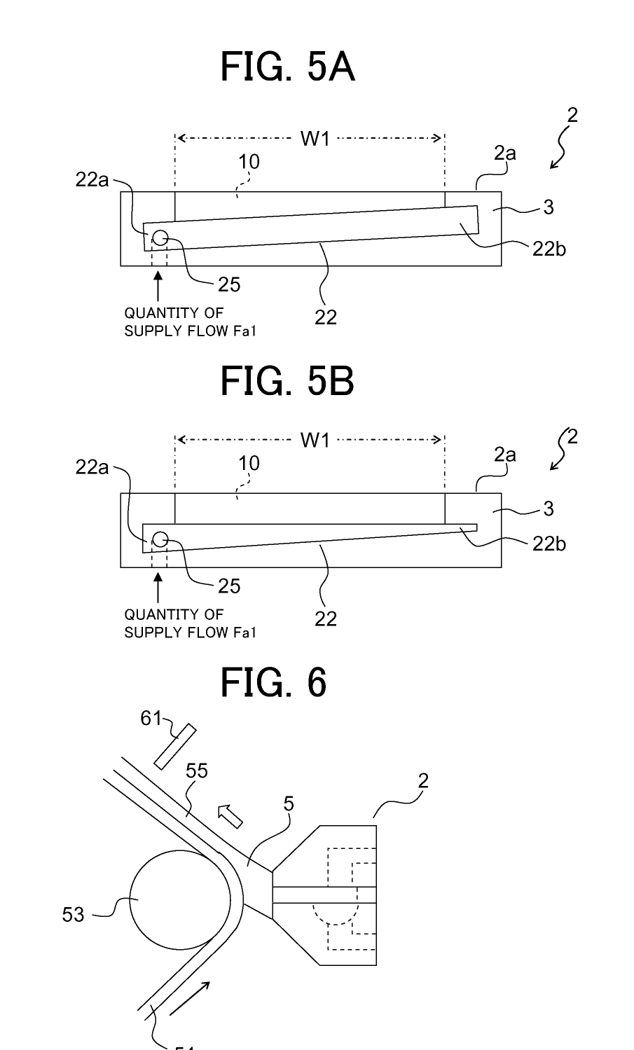

Incidentally, as is illustrated in FIG. 5A, the cavity 22 may be formed so as to be inclined with respect to the above described longitudinal direction so that the cavity 22 approaches the discharge port of the coating liquid 5, which is the opening edge of the slot 10, as the cavity 22 approaches a second end portion (second side) 22b from a first end portion 22a (first side) of the cavity 22, when viewed from the upper part; and the slot 10 may also be formed so that the length in the transverse direction becomes small as the cavity 22 approaches the second end portion 22b side from the above described first end portion 22a side, when viewed from the upper part. Due to the structure formed in this way, the coating liquid 5 can pass through the slot 10 by a smaller pressure, as the cavity 22 approaches the second end portion 22b side from the first end portion 22a side, in other words, as the cavity 22 becomes distant from a liquid supply port 25 which will be described later. Thereby, it becomes possible to make the dispersion in the quantity of the passing flow of the coating liquid passing through the slot 10 smaller along the above described longitudinal direction.

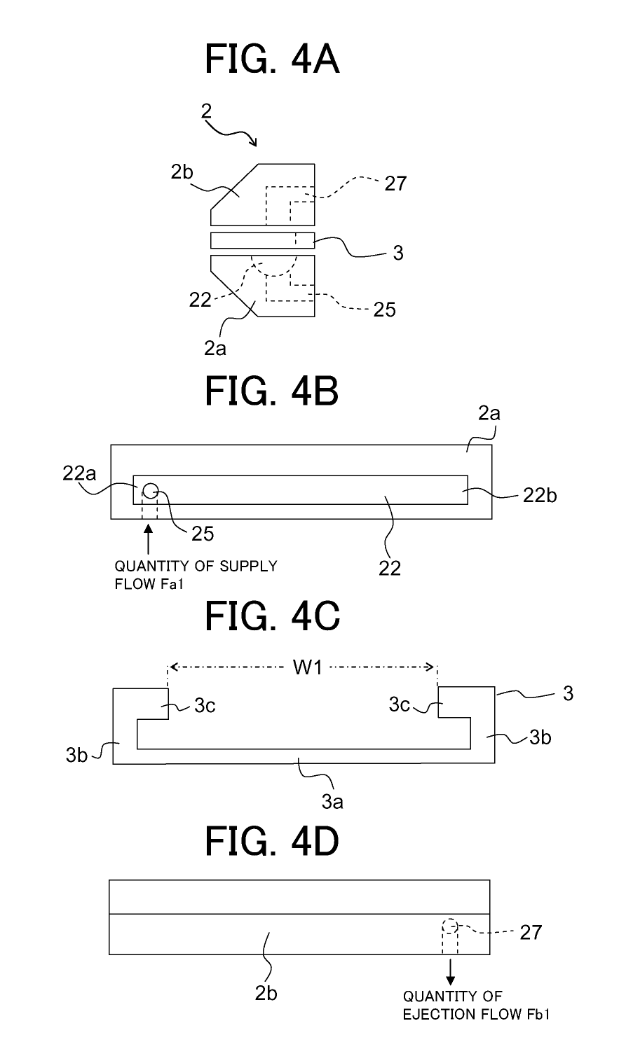

In addition, as is illustrated in FIG. 5B, the cavity 22 may be formed so that the length in the transverse direction of the cavity 22 decreases as the cavity 22 approaches the second end portion 22b side from the first end portion 22a side, when viewed from the upper part; and the slot 10 may also be formed so that the length in the transverse direction is constant throughout the longitudinal direction, when viewed from the upper part. Due to the structure formed in this way, an internal pressure of the coating liquid 5 can be increased as the cavity approaches the second end portion 22b from the first end portion 22a, when compared to the cases illustrated in FIG. 3B and FIG. 4B, and accordingly the dispersion in the quantity of the passing flow of the coating liquid passing through the slot 10 can be decreased throughout the above described longitudinal direction.

In addition, the die 2 is structured so that the coating width of the slot 10 can be changed, by mounting any shim thereon which has been selected from a plurality of shims that have been provided in the die coater 1. For instance, only the selected shim 3 is mounted on the die 2 out of the shim 3 (see FIGS. 2 to 4, and 7) and a shim 4 (see FIG. 8) which are provided in the die coater 1.

As is illustrated in FIG. 4C, the shim 3 has a rectangular base end portion 3a which extends along the above described longitudinal direction, and a pair of rectangular extending portions 3b which form a right angle with the base end portion 3a and extend toward the distal end of the 2 from both ends of the base end portion 3a, and these portions are formed into an approximately U shape as a whole. In addition, the shim 3 has a pair of rectangular projecting portions 3c which project from the distal end of each of the extending portions 3b toward the inner side in parallel to the base end portion 3a, and each of the extending portions 3b and the projecting portions 3c are formed into an approximately L shape as a whole. The distance between the pair of the projecting portions 3c determines the coating width, and W1 (and W2) which are the coating widths that will be described later are determined according to the projecting length of the projecting portions 3c in the above described longitudinal direction (see FIG. 7 and FIG. 8).

In addition, when the cavity 22 and the slot 10 have the above described shapes as illustrated in FIGS. 5A and 5B, a shim 3 (shim 4) having a shape corresponding to these shapes may be used.

In addition, the shim 3 is sandwiched between the first die block 2a and the second die block 2b in the die 2. The shim 3 is mounted on the die 2 by being fixed together with the first die block 2a and the second die block 2b by a not-shown bolt and the like, in a state of being sandwiched between the first die block 2a and the second die block 2b, which will be described later. In addition, the shim 3 is structured so as to be removed from the 2, by removing the above described bolt and separating the first die block 2a and the second die block 2b from each other. Thus, the shim 4 (see FIG. 8) which is structured into a similar shape to the shim 3 except that the coating width is W2 which is smaller than W1 can be mounted on the die 2 in a similar way to that in the above description after the shim 3 has been removed from the die 2. Thereby, the coating width of the slot 10 can be changed to W2 from W1. In addition, on the other hand, the coating width can be changed to W1 from W2 by removing the shim 4 from and mounting the shim 3 on the die.

The die coater may also be structured so that the coating width of the slot 10 is changed by selecting any one shim from three or more shims having different coating widths from each other, and sandwiching the selected shim between the first die block 2a and the second die block 2b.

When these first die block 2a and second the block 2b are fixed together with the shim 3 by a not-shown bolt and the like in such a state, for instance, that the shim 3 is sandwiched between the first die block 2a and the second die block 2b, the cavity 22 and a flow channel of the coating liquid 5, which is formed between the cavity 22 and the slot 10, are formed in the inner side of the die 2. Specifically, the flow channel of the coating liquid is formed by being comparted by the inner surfaces of the facing first die block 2a and second die block 2b, and the shim 3; and the slot 10 having the same height as the thickness of the shim 3 is formed at the distal end of the flow channel.

The liquid supply port 25 which is formed in the first die block 2a communicates with the cavity 22 so that the coating liquid 5 is supplied to the cavity 22 from the supplying section 31, in the first end portion 22a of the cavity 22 in the longitudinal direction of the slot 10. A liquid ejection port 27 which is formed in the second die block 2b communicates with the cavity 22 so that the coating liquid 5 is ejected to the ejecting section 33 from the cavity 22, at the second end portion 22b in the above described longitudinal direction. Incidentally, the liquid ejection port 27 may also be formed in the first die block 2a.

Furthermore, the coater 1 includes the supplying section 31 which supplies the coating liquid 5 to the first end portion 22a in the above described longitudinal direction of the cavity 22 and the ejecting section 33 which ejects the coating liquid 5 from the second end portion 22b in the above described longitudinal direction, and is structured so that a part of the coating liquid 5 which has been supplied from the supplying section 31 moves to the slot 10 from the cavity 22 and passes through the slot, and simultaneously the remaining coating liquid 5 moves in the cavity 22 to the second end portion 22b from the first end portion 22a and is ejected by the ejecting section 33.

The supplying section 31 includes a pump 31a and a flow meter 31b, and is structured so as to supply the coating liquid 5 to the liquid supply port 25 from the storing section 35 of the coating liquid, which is formed of a tank or the like, for instance. In addition, the ejecting section 33 includes a pump 33a and a flow meter 33b, and is structured so as to eject the coating liquid 5 from the liquid ejection port 27 and send the ejected coating liquid 5 to the storing section 35. Specifically, the supplying section 31 and the ejecting section 33 are structured so as to circulate the coating liquid 5 through the cavity 22.

A detection result of the quantity of the supply flow detected by the flow meter 31b of the supplying section 31 and a detection result of the quantity of the ejection flow detected by the flow meter 33b of the ejecting section 33 are sent to the controlling section 63.

The detecting section 61 is structured so as to be capable of detecting a film thickness (thickness) of the coating film 55 which has been formed on the substrate 51. In addition, the detecting section 61 is structured so as to send the detection result to the controlling section 63. An example of the detecting section 61 includes, for instance, an in-line thickness indicator. The in-line thickness indicator is structured so as to be arranged to face the coating film 55 which has been formed on the substrate 51 in a non-contact state, measure the film thickness of the coating film 55, and send the measurement result to the controlling section 63.

In addition, the detecting section 61 is preferably structured so as to be capable of detecting at least the thicknesses in the first end portion 22a side and the second end portion 22b side (see FIG. 3) in the above described longitudinal direction of the coating film 55.

Examples of the detecting section 61 include a stationary type of a detecting section, and a mobile type of a detecting section.

As for the above described stationary type of the detecting section, for instance, a plurality of the detecting sections are provided, and the plurality of the detecting sections are arranged along the above described width direction in a position at which the detecting sections face the coating film 55 in a non-contact state. In addition, the detection result of the plurality of these detecting sections 61 is sent to the controlling section 63. In addition, as for the stationary type of the detecting section, two detecting sections may be arranged along the above described longitudinal direction as is illustrated in FIG. 1, and in addition to this, three or more detecting sections may also be arranged.

As for the above described mobile type of the detecting section, for instance, one detecting section is provided, and the one detecting section is structured so as to detect (scan) the thicknesses of the coating film 55, while moving in the above described longitudinal direction in a position at which the detecting section faces the coating film 55 in a non-contact state. The detection result of this detecting section is determined so as to be sent to the controlling section 63, in a similar way to that in the above description.

In the embodiment illustrated in FIG. 1, the detecting section 61 is a stationary type, two detecting sections are provided, and the detecting sections are structured so as to be capable of detecting the thicknesses in the first end portion 22a side and the second end portion 22b side (see FIG. 3) in the above described longitudinal direction of the coating film 55.

The controlling section 63 is structured, when the coating width has been changed, so as to be capable of controlling the quantity of the supply flow of the coating liquid 5 to be supplied to the first end portion 22a by the supplying section 31 and the quantity of the ejection flow of the coating liquid to be ejected from the second end portion 22b by the ejecting section 33, on the basis of the detection result of the detecting section 61.

The above described quantity of the supply flow can be changed by the pump 31a, and the above described quantity of the ejection flow can be changed by the pump 33a. In addition, the die coater is structured so that the quantity of the passing flow through the whole coating width (hereinafter referred to as quantity of total passing flow) can be adjusted by changing a difference between the above described quantity of the supply flow and the above described quantity of the ejection flow (quantity of supply flow−quantity of ejection flow=quantity of total passing flow). In other words, the above described quantity of the total passing flow corresponds to the quantity of the total discharge flow of the coating liquid 5 discharged from the slot 10. In addition, the above described quantity of the passing flow can be calculated by dividing the above described quantity of the total passing flow by unit coating width. In addition, the amounts of changes of the above described quantity of the supply flow, the above described quantity of the ejection flow and the above described quantity of the passing flow can be each detected by the flow meters 31b and 33b.

The controlling section 63 includes one which is provided, for instance, with a central processing unit (CPU).

In the embodiment of FIG. 1, the controlling section 63 is structured so as to calculate the average value of the film thicknesses in the above described longitudinal direction of the coating film 55, on the basis of the detection result of each of the detecting sections 61. In addition, the controlling section 63 is structured so as to store the calculated average value and the thicknesses which have been detected by the detecting sections.

In addition, the controlling section 63 is structured, when the coating width has been changed, so as to calculate the average value of the film thicknesses in the above described longitudinal direction of the coating film 55 after the coating width has been changed, on the basis of the detection result which has been sent from the detecting sections 61.

The controlling section 63 is structured, when the average value of the film thicknesses after the coating width has been changed becomes larger than the average value of the film thicknesses before the coating width is changed (which corresponds to the case in which the coating width has been decreased), so as to control the quantity of the passing flow of the coating liquid 5 passing through the slot 10 per unit coating width so as to become constant before and after the coating width is changed, and the quantity of the supply flow by the supplying section 31 so as to decrease as compared to that before the coating width is changed. Thereby, the average value of the film thicknesses after the coating width has been changed can be close to the average value of the film thicknesses before the coating width is changed.

Furthermore, in the as-is state, the film thickness in the above described second end portion 22b side (downstream side) becomes smaller than the state before the coating width is changed, and accordingly the controlling section 63 is structured so as to control the quantity of the supply flow by the supplying section 31 and the quantity of the ejection flow by the ejecting section 33 so as to decrease as compared to those before the coating width is changed, while keeping the above described quantity of the passing flow constant.

For information, such a control as to decrease both of the values may be executed on the basis of the detection result only of the detecting section 61 in the second end portion 22b side, and may also be executed on the basis of the dispersion between the detection result of the detecting section 61 in the second end portion 22b side and the detection result of the detecting section 61 in the first end portion 22a side (upstream side).

On the other hand, the controlling section 63 is structured, when the average value of the film thicknesses after the coating width has been changed becomes smaller than the average value of the film thicknesses before the coating width is changed (which corresponds to the case in which the coating width has been increased), so as to control the quantity of the passing flow of the coating liquid 5 passing through the slot 10 per unit coating width so as to become constant before and after the coating width is changed, and the quantity of the supply flow by the supplying section 31 so as to increase as compared to that before the coating width is changed. Thereby, the average value of the film thicknesses after the coating width has been changed can be close to the average value of the film thicknesses before the change.

Furthermore, in the as-is state, the film thickness in the above described second end portion 22b side becomes larger than that before the coating width is changed, and accordingly the controlling section 63 is structured so as to control the quantity of the supply flow by the supplying section 31 and the quantity of the ejection flow by the ejecting section 33 so as to become large, while keeping the above described quantity of the passing flow constant.

For information, such a control as to increase both of the values may be executed on the basis of the detection result only of the detecting section 61 in the second end portion 22b side, and may also be executed on the basis of the dispersion between the detection result in the second end portion 22b side and the detection result of the detecting section 61 in the first end portion 22a side.

In addition, the controlling section 63 is structured so as to calculate the above described quantity of the supply flow, the quantity of the ejection flow and the above described quantity of the passing flow, on the basis of the detection result of the above described flow meters 31b and 33b, and so as to change the above described quantity of the supply flow by the pump 31a and the above described quantity of the ejection flow by the pump 33a, on the basis of such a calculation result.

The die coater of the present embodiment can control the above described quantity of the passing flow so as to become constant before and after the coating width is changed, and can control the above described quantity of the supply flow and quantity of the ejection flow so as to decrease as compared to those before the coating width is changed, on the basis of the detection result of the thickness of the coating film, when the coating width has been decreased. Thereby, the die coater can suppress the phenomenon that a pressure loss in the coating liquid 5 which moves through the cavity 22 in a second end portion 22b side (downstream side) with respect to that in a first end portion 22a side (upstream side) changes before and after the coating width is changed.

In addition, when the coating width has been increased, the die coater can control the above described quantity of the passing flow so as to become constant before and after the coating width is changed, and can control the above described quantity of the supply flow and the above described quantity of the ejection flow so as to increase as compared to those before the coating width is changed, on the basis of the detection result of the thickness of the coating film. Thereby, the die coater can suppress the phenomenon that the above described pressure loss changes before and after the coating width is changed.

Thus, because of being provided with the above described detecting section 61 and controlling section 63, the die coater can suppress the phenomenon that the above described pressure loss changes before and after the coating width is changed, even though the coating width has been appropriately changed, and can comparatively decrease the dispersion in the quantity of the passing flow of the coating liquid passing through the slot 10, in a longitudinal direction (width direction of coating film) of the slot 10.

Accordingly, the die coater can appropriately change the coating width in the longitudinal direction of the slot 10 and simultaneously achieve a coating film having a comparatively small dispersion in the film thickness throughout the longitudinal direction.

The die coater 1 of the present embodiment can be preferably used for a coating liquid 5 in which n is outside a range of 0.99 to 1.01 in the equation of μ=μ₀·γ^{n·1} obtained for viscosity [Pa·s], a zero shear viscosity μ₀ [Pa·s] and a shear rate γ [1/s], when the viscosity is measured in a range of the shear rate of 20 to 2,000 (1/s) at a concentration and a temperature at which the coating liquid is applied, with the use of a rheometer (RheoStress RS1 made by ThermoHaake). In other words, the die coater can be preferably used for the coating liquid of which the viscosity changes comparatively largely when the shear rate changes. In addition, the die coater can be more preferably used for the coating liquid 5 of which the above described n is outside a range of 0.95 to 1.05.

In the coating liquid of which the above described n is outside the range of 0.99 to 1.01, as the shear rate increases, the viscosity increases or decreases largely, and the discharge quantity of the coating liquid 5 discharged from the slot 10 tends to easily disperse in the longitudinal direction, as compared to the coating liquid of which the above described n is within the range of 0.99 to 1.01. However, the die coater 1 of the present embodiment can suppress the dispersion in the discharge quantity discharged from the slot 10 even when the coating liquid of which the discharge quantity tends to easily disperse is used in this way, which is accordingly useful.

An example of the coating liquid 5 includes a polymer solution. Examples of the polymer solution include a rubber-based solution, an acrylic solution, a silicone-based solution, a urethane-based solution, a vinyl alkyl ether-based solution, a polyvinyl alcohol-based solution, a polyvinylpyrrolidone-based solution, a polyacrylamide-based solution and a cellulose-based solution.

In addition, in the die coater 1 of the present embodiment, the controlling section 63 is preferably structured so that when the thickness of the coating film 55 is larger than that before the coating width is changed, the controlling section controls the quantity of the passing flow of the coating liquid 5 passing through the slot 10 per unit coating width so as to become constant before and after the coating width is changed, and also controls the above described quantity of the supply flow and the above described quantity of the ejection flow so as to decrease as compared to those before the coating width is changed, and so that when the thickness of the coating film 55 is smaller than that before the coating width is changed, the controlling section controls the above described quantity of the passing flow so as to become constant before and after the coating width is changed, and also controls the above described quantity of the supply flow and the above described quantity of the ejection flow so as to increase as compared to those before the coating width is changed, on the basis of the detection result of the detecting section 61.

In other words, the die coater is preferably structured, when the coating width has been decreased as compared to that before the coating width is changed (for instance, coating width has been decreased to W2 of FIG. 8 from W1 of FIG. 7), so as to decrease the above described quantity of the supply flow and the above described quantity of the ejection flow as compared to those before the coating width is changed while keeping the above described quantity of the passing flow constant before and after the coating width is changed, and on the other hand, when the coating width has been increased as compared to that before the coating width is changed (for instance, coating width has been increased to W1 of FIG. 7 from W2 of FIG. 8), so as to increase the above described quantity of the supply flow and the above described quantity of the ejection flow as compared to those before the coating width is changed while keeping the above described quantity of the passing flow constant before and after the coating width is changed.

This structure can more surely suppress the dispersion in the discharge quantity of the coating liquid 5 discharged from the slot 10, in the above described longitudinal direction.

Next, a method for producing a coating film using the above described die coater 1 will be described below.

A method for producing the coating film in the present embodiment is a method of producing the coating film 55 (see FIG. 6) on a substrate 51 (see FIG. 6) by making a slot 10 discharge a coating liquid 5 therefrom with the use of the above described die coater 1 provided with the slot 10 which discharges the coating liquid 5 (see FIG. 6) therefrom and a cavity 22 which supplies the coating liquid to the slot 10 therefrom. In addition, the method for producing the coating film includes a coating step of supplying the coating liquid 5 to a first end portion (first side) 22a in the longitudinal direction of the cavity 22, making a part of the supplied coating liquid 5 pass through the slot 10, simultaneously ejecting the remaining part of the coating liquid from a second end portion (second side) 22b in the longitudinal direction of the cavity 22 and thereby discharging a part of the supplied coating liquid 5 onto the substrate 51 from the slot 10. In addition, in the coating step, the die coater makes the slot 10 discharge a part of the coating liquid 5 to form the coating film on the substrate 51, when the coating width has been changed so as to become small (here, coating width is changed to W2 from W1), by keeping the quantity of the passing flow of the coating liquid 5 passing through the slot 10 per unit coating width constant before and after the coating width is changed, and also decreasing the quantity of the supply flow of the coating liquid 5 to be supplied to the first end portion 22a and the quantity of the ejection flow of the coating liquid 5 to be ejected from the second end portion 22b as compared to those before the coating width is changed, and when the coating width has been changed so as to become large (here, coating width is changed to W1 from W2), by keeping the above described quantity of the passing flow constant before and after the coating width is changed, and also increasing the above described quantity of the supply flow and the above described quantity of the ejection flow as compared to those before the coating width is changed.

The substrate 51 can employ a strip-shaped substrate having flexibility, which includes a film formed from, for instance: any one or more resins selected from a cellulose resin such as triacetyl cellulose (TAC), a polyester resin such as polyethylene terephthalate (PET), a polyether sulfone resin, a polysulfone resin, a polycarbonate resin, a polyamide resin, a polyimide resin, a polyolefin resin such as polyethylene (PE), a cyclic polyolefin resin (norbornene resin), a (meth)acrylic resin, a polyarylate resin, a polystyrene resin and a polyvinyl alcohol (PVA) resin; or a copolymer, a mixture and the like of two or more resins selected from the resins. In addition, the substrate 51 can be relatively moved with respect to the die 2 while being supported by a roller member 53, as is illustrated in FIG. 6, for instance.

The above described production method uses the die coater 1 which is structured, for instance, so as to be capable of changing the coating width of the slot 10, by making any one shim selected from a plurality of shims (here, shim 3 and shim 4) which can be detachably mounted on the die 2 (specifically, space between the first die block 2a and the second die block 2b) and have different coating widths from each other to be mounted on the space between the above described blocks, as described above.

Suppose that the coating width is set at W1 by the shim 3 which has been mounted on the die 2, as is illustrated in FIG. 7, and that the above described quantity of the supply flow at this time is set at Fa1, the above described quantity of the ejection flow is set at Fb1 and the total quantity of the passing flow is set at Fc1. At this time, the above described quantity of the passing flow results in being set at Fc1/W1.

From this state, the coating width is changed to decrease to W2 from W1 by removing the shim 3 from the die 2 and mounting the shim 4 in place of the shim 3. At this time, when the above described detecting section 61 detects the film thickness of the coating film 55, the controlling section 63 calculates the average value of the film thicknesses of the coating film 55 after the coating width has been changed, on the basis of the detection result. When the average value of the film thickness after the coating width has been increased as compared to that before the coating width is changed, the controlling section 63 controls the quantity of the supply flow so as to be smaller than Fa1 so that the total quantity of the passing flow is changed to Fc2 from Fc1, while keeping the quantity of the ejection flow at constant Fb1. At this time, Fc2 which is the above described total quantity of the passing flow passing through the slot 10 results in being set at Fc2=W2×Fc1/W1 so that the above described quantity of the passing flow (quantity of the passing flow per unit coating width) becomes the same value as Fc1/W1. Thereby, the above described quantity of the passing flow is kept constant before and after the coating width is changed. Furthermore, because the film thickness in the above described second end portion 22b side (downstream side) decreases in the as-is state, the controlling section 63 changes the quantity of the ejection flow so as to decrease to Fb2 from Fb1, while keeping the total quantity of the passing flow at constant Fc2 and decreasing the quantity of the supply flow finally to Fa2. In other words, the controlling section 63 changes the above described quantity of the supply flow to Fa2 from Fa1 before the coating width is changed, and changes the above described quantity of the ejection flow to Fb2 from Fb1 before the coating width is changed, on the basis of the detection result of the detecting section 61, as is illustrated in FIG. 8; and thereby decreases the above described quantity of the supply flow and the above described quantity of the ejection flow as compared to those before the coating width is changed, while keeping the above described quantity of the passing flow constant before and after the coating width is changed.

Then, the die coater supplies the coating liquid 5 to the first end portion 22a in the above described longitudinal direction of the cavity 22, in a state of having decreased the above described quantity of the ejection flow as compared to that before the coating width is changed, while keeping the above described quantity of the passing flow constant, in the above way. In addition, the die coater makes the slot 10 discharge the coating liquid 5 onto the substrate 51, by making a part of the supplied coating liquid 5 pass through the slot 10, simultaneously making the remaining coating liquid move from the first end portion 22a of the cavity 22 to the second end portion 22b in the above described longitudinal direction, and making the coating liquid 5 ejected from the second end portion 22b.

Thus, when the coating width is changed so as to become small, the die coater decreases the above described quantity of the supply flow and the above described quantity of the ejection flow as compared to those before the coating width is changed, while keeping the above described quantity of the passing flow constant before and after the coating width is changed, and thereby can suppress the change of a pressure loss in the second end portion 22b side with respect to the first end portion 22a side in the coating liquid 5 moving through the cavity 22, which occurs before and after the coating width is changed.

On the other hand, suppose the case that the coating width is set at W2 by the shim 4 which has been firstly mounted on the die 2, as is illustrated in FIG. 8, in contrast to the above described case, and that the above described quantity of the supply flow at this time is set at Fa2, the above described quantity of the ejection flow is set at Fb2 and the total quantity of the passing flow is set at Fc2.

From this state, the coating width is changed so as to increase from W2 to W1 by removing the shim 4 from the die 2 and mounting the shim 3 in place of the shim 4. At this time, when the above described detecting section 61 detects the film thickness of the coating film 55, the controlling section 63 calculates the average value of the film thicknesses of the coating film 55 after the coating width has been changed, on the basis of this detection result. When the average value of the film thickness after the coating width has been changed has decreased as compared to that before the coating width is changed, the controlling section 63 controls the quantity of the supply flow so as to be larger than Fa2 so that the total quantity of the passing flow is changed to Fc1 from Fc2, while keeping the quantity of the ejection flow at constant Fb2. At this time, Fc1 which is the above described total quantity of the passing flow passing to the slot 10 from the cavity 22 results in being set at Fc1=W1×Fc2/W2 so that the above described quantity of the passing flow (quantity of the passing flow per unit coating width) becomes the same value as Fc2/W2. Thereby, the above described quantity of the passing flow is kept constant before and after the coating width is changed. Furthermore, because the film thickness in the above described second end portion 22b side (downstream side) increases in the as-is state, the controlling section 63 changes the quantity of the ejection flow so as to increase to Fb1 from Fb2 and increasing the quantity of the supply flow finally to Fa1 while keeping the total quantity of the passing flow at constant Fc1. In other words, the controlling section 63 changes the above described quantity of the supply flow to Fa1 from Fa2 before the coating width is changed, and changes the above described quantity of the ejection flow to Fb1 from Fb2 before the change, on the basis of the detection result of the detecting section 61, as is illustrated in FIG. 7; and thereby increases the above described quantity of the supply flow and the above described quantity of the ejection flow as compared to those before the coating width is changed, while keeping the above described quantity of the passing flow constant before and after the coating width is changed.

Then, the die coater supplies the coating liquid 5 to the first end portion 22a in the above described longitudinal direction of the cavity 22, in a state of having increased the above described quantity of the ejection flow as compared to that before the change while keeping the above described quantity of the passing flow constant, in the above way. In addition, the die coater makes the slot 10 discharge the coating liquid 5 onto the substrate 51 by making a part of the supplied coating liquid 5 pass through the slot 10, simultaneously making the remaining coating liquid move from the first end portion 22a of the cavity 22 to the second end portion 22b in the above described longitudinal direction, and making the coating liquid 5 ejected from the second end portion 22b.

Thus, when the coating width is changed so as to become large, the die coater increases the above described quantity of the supply flow and the above described quantity of the ejection flow as compared to those before the coating width is changed, while keeping the above described quantity of the passing flow constant before and after the coating width is changed, and thereby can suppress the change of the pressure loss in the second end portion 22b side with respect to the first end portion 22a side in the coating liquid 5 passing through the cavity 22, which occurs before and after the coating width is changed.

The production method according to the present embodiment can suppress the phenomenon that the pressure loss in the second side (downstream side) with respect to the first side (upstream side) changes in the coating liquid which moves through the cavity before and after the coating width is changed, even though the coating width has been appropriately changed. Thereby, the production method can comparatively decrease the dispersion in the quantity of the passing flow of the coating liquid passing through the slot 10, in the above described longitudinal direction.

Accordingly, the production method makes it possible to appropriately change the coating width in the longitudinal direction of the slot 10 and simultaneously achieve a coating film having a comparatively small dispersion in the film thickness throughout the longitudinal direction.

The coater and the method for producing the coating film of the present invention are as described above, but the present invention is not limited to the above described embodiment, and can be appropriately modified in a range of the scope of the present invention.

For instance, in the above described embodiment, such a structure has been described as to circulate the coating liquid 5 which has been ejected from the cavity 22 to the cavity 22, but in addition to the structure, such a structure can also be adopted as to recover the ejected coating liquid 5. In addition, in the above described embodiment, such a structure has been described as to be capable of changing the coating width of the slot 10 by selecting a shim from a plurality of shims, but another structure can be adopted as long as the structure can change the coating width of the slot 10.

### EXAMPLE

Next, the present invention will be described in more detail below with reference to an example, but the present invention is not limited to the example.

A substrate which moved relatively to a die coater in a similar way to that illustrated in FIG. 6 was coated with the use of a die coater which is similar to the die coater illustrated in FIG. 1. In addition, a transportation speed of the substrate was set at 30 m/min, a temperature at which a coating liquid was applied was set at 23° C., and the coating liquid was applied onto the substrate so that an average film thickness of the coating film became 23 μm.

A liquid in which an acrylic tackiness agent was dissolved in a mixed liquid of toluene and ethyl acetate was used as the coating liquid. The viscosity of this acrylic tackiness agent was measured with the use of a rheometer (RheoStress RS1 made by ThermoHaake), while the coating liquid was applied at a temperature of 23° C. in a range of a shear rate of 20 to 2,000 (1/s). As a result, the zero shear viscosity μ₀ was 40 Pa·s and n was 0.37 in the equation of μ=μ₀·γ^{n·1} obtained for the viscosity μ [Pa·s], the zero shear viscosity μ₀ [Pa·s] and a shear rate γ [1/s].

A strip-shaped flexible substrate of a PET film (made by Mitsubishi Plastics, Inc., product name of DIAFOIL, 900 mm in width, and 38 μm in thickness), which was wound into a roll shape, was used as the substrate.

In addition, the coating width of the slot, the quantity of the supply flow of the coating liquid to be supplied to the cavity, the quantity of the ejection flow of the coating liquid to be ejected from the cavity, and the total quantity of the passing flow of the coating liquid were set as described below, and the coating film was formed from the coating liquid which was discharged onto the substrate from the slot. Then, the dispersion in the film thicknesses of the obtained coating film was measured. Specifically, the thicknesses of the obtained coating film were measured at a pitch of 1 mm in the width direction of the substrate with an optical interference type film thickness meter, and a difference [mm] between the maximum value and the minimum value in the measurement result was calculated as the dispersion in the film thicknesses. Incidentally, in Table 1, the case in which the quantity of the ejection flow is “0” means that the coating liquid is not ejected from the liquid ejection port.

TABLE 1
Dispersion in film thickness (%)

| | Quantity of flow [L/min] | | | Coating width [mm] | | |
|---|---|---|---|---|---|---|
| | Supply | Ejection | Pass | 400 | 600 | 800 |
| No. 1 | 2.4 | 0 | 2.4 | 3.3 | — | — |
| No. 2 | 3.4 | 1 | 2.4 | 1.2 | — | — |
| No. 3 | 3.9 | 1.5 | 2.4 | 0.6 | — | — |
| No. 4 | 4.4 | 2 | 2.4 | 0.7 | — | — |
| No. 5 | 4.9 | 2.5 | 2.4 | 1.1 | — | — |
| No. 6 | 5.4 | 3 | 2.4 | 1.6 | — | — |
| No. 7 | 6.4 | 4 | 2.4 | 2.7 | — | — |
| No. 8 | 3.6 | 0 | 3.6 | — | 5.8 | — |
| No. 9 | 4.6 | 1 | 3.6 | — | 3 | — |
| No. 10 | 5.1 | 1.5 | 3.6 | — | 2 | — |
| No. 11 | 5.6 | 2 | 3.6 | — | 1.3 | — |
| No. 12 | 6.1 | 2.5 | 3.6 | — | 0.8 | — |
| No. 13 | 6.6 | 3 | 3.6 | — | 1.4 | — |
| No. 14 | 7.6 | 4 | 3.6 | — | 2.4 | — |
| No. 15 | 4.8 | 0 | 4.8 | — | — | 8.2 |
| No. 16 | 5.8 | 1 | 4.8 | — | — | 4.9 |
| No. 17 | 6.3 | 1.5 | 4.8 | — | — | 3.7 |
| No. 18 | 6.8 | 2 | 4.8 | — | — | 2.7 |
| No. 19 | 7.3 | 2.5 | 4.8 | — | — | 1.8 |
| No. 20 | 7.8 | 3 | 4.8 | — | — | 1.3 |
| No. 21 | 8.3 | 3.5 | 4.8 | — | — | 1.8 |
| No. 22 | 8.8 | 4 | 4.8 | — | — | 2.4 |

As is illustrated in Table 1, when the coating width was 400 mm and the coating liquid was not ejected (No. 1), the dispersion in the film thickness was extremely large, but when the coating liquid was ejected (No. 2 to No. 7), the dispersion in the film thickness was far small as compared to that of No. 1. In addition, when the quantity of the ejection flow was too large, the dispersion in the film thickness tended to increase on the contrary, and when the quantity of the ejection flow was 1.5 L/min (No. 3), the dispersion in the film thickness was the smallest. As a result of this, it was found that when the coating width was 400 mm, the optimal coating condition to be set was No. 3.

Next, the coating width was changed to 600 mm from 400 mm. At this time, the quantity of the ejection flow was kept at 1.5 L/min which was the same quantity as that in the condition of the above described No. 3. In addition, the quantity of the supply flow was set at 5.1 L/min. By setting the quantities in this way, the total quantity of the passing flow was set at 3.6 L/min (No. 10) so that the quantity of the passing flow per unit coating width (100 mm) became 0.6 L which was the same quantity as that in the case in which the coating width was 400 mm. As a result, the dispersion in the film thickness increased as compared to that of No. 3.

Then, the quantity of the ejection flow was increased (No. 11 to No. 13) while the total quantity of the passing flow was kept at constant 3.6 L/min. As a result, the dispersion in the film thickness decreased. In addition, when the quantity of the ejection flow was too large, the dispersion in the film thickness tended to increase (No. 14) on the contrary, and when the quantity of the ejection flow was 2.5 L/min (No. 12), the dispersion in the film thickness was smallest.

As a result of this, it was found that when the coating width was 600 mm, the optimal coating condition to be set was No. 12.

On the other hand, the quantity of the ejection flow was decreased (No. 9) while the total quantity of the passing flow was kept at constant 3.6 L/min. As a result, the dispersion in the film thickness further increased as compared to that of No. 10.

Next, the coating width was changed to 800 mm from 400 mm. At this time, the quantity of the ejection flow was kept at 1.5 L/min which was the same quantity as that in the condition of above described No. 3. In addition, the quantity of the supply flow was set at 6.3 L/min. By setting the quantities in this way, the total quantity of the passing flow was set at 4.8 L/min (No. 17) so that the quantity of the passing flow per unit coating width (100 mm) became 0.6 L which was the same quantity as that in the case in which the coating width was 400 mm. As a result, the dispersion in the film thickness increased as compared to that of No. 3.

Then, the quantity of the ejection flow was increased (No. 18 to No. 22) while the total quantity of the passing flow was kept at constant 4.8 L/min. As a result, the dispersion in the film thickness decreased. In addition, when the quantity of the ejection flow was too large, the dispersion in the film thickness tended to increase (No. 21 and No. 22) on the contrary, and when the quantity of the ejection flow was 3 L/min (No. 20), the dispersion in the film thickness was smallest.

As a result of this, it was found that when the coating width was 800 mm, the optimal coating condition to be set was No. 20.

On the other hand, the quantity of the ejection flow was decreased (No. 16) while the total quantity of the passing flow was kept at constant 4.8 L/min. As a result, the dispersion in the film thickness further increased as compared to that of No. 17.

Next, the coating width was changed to 800 mm from 600 mm. At this time, the quantity of the ejection flow was kept at 2.5 L/min which was the same quantity as that in the condition of the above described No. 12. In addition, the quantity of the supply flow was set at 7.3 L/min. By setting the quantities in this way, the total quantity of the passing flow was set at 4.8 L/min (No. 19) so that the quantity of the passing flow per unit coating width (100 mm) became 0.6 L which was the same quantity as that in the case in which the coating width was 600 mm. As a result, the dispersion in the film thickness increased as compared to that of No. 12.

Then, the quantity of the ejection flow was increased (No. 20) while the total quantity of the passing flow was kept at constant 4.8 L/min. As a result, the dispersion in the film thickness decreased. In addition, when the quantity of the ejection flow was too large, the dispersion in the film thickness tended to increase (No. 21 and No. 22) on the contrary, and when the quantity of the ejection flow was 3 L/min (No. 20), the dispersion in the film thickness was smallest.

As a result of this, it was found that when the coating width was 800 mm, the optimal coating condition to be set was No. 20.

On the other hand, the quantity of the ejection flow was decreased (No. 16 to No. 18) while the total quantity of the passing flow was kept at constant 4.8 L/min. As a result, the dispersion in the film thickness further increased as compared to that of No. 19.

From the above described result, it was found that when the coating width was increased, the dispersion in the film thickness could be suppressed by increasing the quantity of the ejection flow while keeping the quantity of the passing flow per unit coating width constant.

On the other hand, on the contrary to the above description, as is illustrated in Table 1, when the coating width was 800 mm and the coating liquid was not ejected (No. 15), the dispersion in the film thickness was extremely large, but when the coating liquid was ejected (No. 16 to No. 22), the dispersion in the film thickness was far small as compared to that of No. 15. In addition, when the quantity of the ejection flow was too large, the dispersion in the film thickness tended to increase on the contrary, and when the quantity of the ejection flow was 3 L/min (No. 20), the dispersion in the film thickness was the smallest. As a result of this, it was found that when the coating width was 800 mm, the optimal coating condition to be set was No. 20.

Next, the coating width was changed to 600 mm from 800 mm. At this time, the quantity of the ejection flow was kept at 3 L/min which was the same quantity as that in the condition of the above described No. 20. In addition, the quantity of the supply flow was set at 6.6 L/min. By setting the quantities in this way, the total quantity of the passing flow was set at 3.6 L/min (No. 13) so that the quantity of the passing flow per unit coating width (100 mm) became 0.6 L which was the same quantity as that in the case in which the coating width was 800 mm. As a result, the dispersion in the film thickness increased as compared to that of No. 20.

Then, the quantity of the ejection flow was decreased (No. 11 and No. 12) while the total quantity of the passing flow was kept at constant 3.6 L/min. As a result, the dispersion in the film thickness decreased. In addition, when the quantity of the ejection flow was too small, the dispersion in the film thickness tended to increase (No. 9 and No. 10) on the contrary, and when the quantity of the ejection flow was 2.5 L/min (No. 12), the dispersion in the film thickness was smallest.

As a result of this, it was found that when the coating width was 600 mm, the optimal coating condition to be set was No. 12.

On the other hand, the quantity of the ejection flow was increased (No. 14) while the total quantity of the passing flow was kept at constant 3.6 L/min. As a result, the dispersion in the film thickness further increased as compared to that of No. 13.

Next, the coating width was changed to 400 mm from 800 mm. At this time, the quantity of the ejection flow was kept at 3 L/min which was the same quantity as that in the condition of the above described No. 20. In addition, the quantity of the supply flow was set at 5.4 L/min. By setting the quantities in this way, the total quantity of the passing flow was set at 2.4 L/min (No. 6) so that the quantity of the passing flow per unit coating width (100 mm) became 0.6 L which was the same quantity as that in the case in which the coating width was 800 mm. As a result, the dispersion in the film thickness increased as compared to that of No. 20.

Then, the quantity of the ejection flow was decreased (No. 2 to No. 5) while the total quantity of the passing flow was kept at constant 2.4 L/min. As a result, the dispersion in the film thickness decreased. In addition, when the quantity of the ejection flow was too small, the dispersion in the film thickness tended to increase (No. 2) on the contrary, and when the quantity of the ejection flow was 1.5 L/min (No. 3), the dispersion in the film thickness was smallest.

As a result of this, it was found that when the coating width was 400 mm, the optimal coating condition to be set was No. 3.

On the other hand, the quantity of the ejection flow was increased (No. 7) while the total quantity of the passing flow was kept at constant 2.4 L/min. As a result, the dispersion in the film thickness further increased as compared to that of No. 6.

Next, the coating width was changed to 400 mm from 600 mm. At this time, the quantity of the ejection flow was kept at 2.5 L/min which was the same quantity as that in the condition of the above described No. 12. In addition, the quantity of the supply flow was set at 4.9 L/min. By setting the quantities in this way, the total quantity of the passing flow was set at 2.4 L/min (No. 5) so that the quantity of the passing flow per unit coating width (100 mm) became 0.6 L which was the same quantity as that in the case in which the coating width was 600 mm. As a result, the dispersion in the film thickness increased as compared to that of No. 12.

Then, the quantity of the ejection flow was decreased (No. 3 and No. 4) while the total quantity of the passing flow was kept at constant 2.4 L/min. As a result, the dispersion in the film thickness decreased. In addition, when the quantity of the ejection flow was too small, the dispersion in the film thickness tended to increase (No. 2) on the contrary, and when the quantity of the ejection flow was 1.5 L/min (No. 3), the dispersion in the film thickness was smallest.

As a result of this, it was found that when the coating width was 400 mm, the optimal coating condition to be set was No. 3.

On the other hand, the quantity of the ejection flow was increased (No. 6 and No. 7) while the total quantity of the passing flow was kept at constant 2.4 L/min. As a result, the dispersion in the film thickness further increased as compared to that of No. 5.

From the above described result, it was found that when the coating width was decreased, the dispersion in the film thickness could be suppressed by decreasing the quantity of the ejection flow while keeping the quantity of the passing flow per unit coating width constant. In addition, it was found that the dispersion in the film thickness could be suppressed by detecting the film thickness of the coating film, and controlling the quantity of the supply flow and the quantity of the ejection flow on the basis of the detection result of such film thickness.

### FIG. 1

### #1 COATING LIQUID

### FIG. 3B

### #1 QUANTITY OF SUPPLY FLOW

### #2 QUANTITY OF EJECTION FLOW

### FIG. 4B

### #1 QUANTITY OF SUPPLY FLOW

### FIG. 4D

### #1 QUANTITY OF EJECTION FLOW

### FIG. 5A

### #1 QUANTITY OF SUPPLY FLOW

### FIG. 5B

### #1 QUANTITY OF SUPPLY FLOW

### FIG. 7

### #1 QUANTITY OF SUPPLY FLOW

### #2 TOTAL QUANTITY OF PASSING FLOW

### #3 QUANTITY OF EJECTION FLOW

### FIG. 8

### #1 QUANTITY OF SUPPLY FLOW

### #2 TOTAL QUANTITY OF PASSING FLOW

#3 QUANTITY OF EJECTION FLOW

What is claimed is:

1. A die coater which has a slot that discharges a coating liquid and a cavity that is arranged along a longitudinal direction of the slot and supplies the coating liquid to the slot, and discharges the coating liquid onto a substrate from the slot to form a coating film on the substrate, wherein
the die coater is structured so as to be capable of changing a coating width in the longitudinal direction of the slot, and comprises:
a supplying section which supplies the coating liquid to a first side in the longitudinal direction of the cavity, and an ejecting section which ejects the coating liquid from a second side in the longitudinal direction, wherein the sections are structured so that a part of the coating liquid supplied to the cavity by the supplying section passes through the slot, and simultaneously the remaining part of the coating liquid is ejected by the ejecting section;
a detecting section which can detect a thickness of the coating film formed on the substrate; and
a controlling section which can control the quantity of a supply flow of the coating liquid to be supplied by the supplying section and the quantity of an ejection flow of the coating liquid to be ejected by the ejecting section, on the basis of a detection result of the detecting section, when the coating width has been changed.

2. The die coater according to claim 1, wherein
the controlling section is structured so that when the thickness of the coating film is larger than that before the coating width is changed, the controlling section controls the quantity of a passing flow of the coating liquid passing through the slot per unit coating width so as to become constant before and after the coating width is changed, and controls the quantity of the supply flow and the quantity of the ejection flow so as to decrease as compared to those before the coating width is changed, and
so that when the thickness of the coating film is smaller than that before the coating width is changed, the controlling section controls the quantity of the passing flow so as to become constant before and after the coating width is changed, and controls the quantity of the supply flow and the quantity of the ejection flow so as to increase as compared to those before the coating width is changed, on the basis of the detection result of the detecting section.

3. The die coater according to claim 1, wherein the coating liquid has such viscosity that when the viscosity is measured in a range of a shear rate of 20 to 2,000 (1/s), n is outside a range of 0.99 to 1.01 in the equation of μ=μ₀·γ^{n·1} obtained for the viscosity μ [Pa·s], a zero shear viscosity μ₀ [Pa·s] and a shear rate γ [1/s].

4. The die coater according to claim 1, wherein the coating liquid is one or more solutions selected from the group consisting of a rubber-based solution, an acrylic solution, a silicone-based solution, a urethane-based solution, a vinyl alkyl ether-based solution, a polyvinyl alcohol-based solution, a polyvinylpyrrolidone-based solution, a polyacrylamide-based solution, and a cellulose-based solution.

5. A method for producing a coating film, which produces the coating film on a substrate, comprising:
a coating step of using a die coater provided with a slot which discharges a coating liquid and a cavity which supplies the coating liquid to the slot, supplying the coating liquid to a first side in a longitudinal direction of the cavity, passing a part of the supplied coating liquid through the slot, simultaneously ejecting the remaining part of the coating liquid from a second side in the longitudinal direction of the cavity, and thereby discharging the part of the coating liquid onto the substrate from the slot, wherein
in the coating step, the coating film is produced on the substrate from the part of the coating liquid which has been discharged from the slot, wherein
when the coating width has been changed so as to become small, the quantity of a passing flow of the coating liquid passing through the slot per unit coating width is controlled so as to be constant before and after the coating width is changed, and the quantity of a supply flow of the coating liquid to be supplied to the first side and the quantity of an ejection flow of the coating liquid to be ejected from the second side are controlled so as to decrease as compared to those before the coating width is changed; and
when the coating width has been changed so as to become large, the quantity of the passing flow is controlled so as to be constant before and after the coating width is changed, and the quantity of the supply flow and the quantity of the ejection flow are controlled so as to increase as compared to those before the coating width is changed.
